(19) United States
(12) Patent Application Publication
(10) Pub. No.: US 2011/0099810 A1
(43) Pub. Date: May 5, 2011

(54) METHOD FOR REPAIRING A GAS TURBINE COMPONENT

(76) Inventors: Alexander STANKOWSKI, Wurenlingen (CH); Simone HÖVEL, Ennetbaden (CH); Lukas RICKENBACHER, Basel (CH); Matthias HÖBEL, Windisch (CH); Günter AMBROSY, Baden (CH)

(21) Appl. No.: 12/916,032

(22) Filed: Oct. 29, 2010

Related U.S. Application Data
(60) Provisional application No. 61/256,399, filed on Oct. 30, 2009.

(51) Int. Cl. B23P 17/00

(52) U.S. Cl. 29/888

(57) ABSTRACT

A method for repairing an ex-service gas turbine component (10) includes the steps of: removing a damaged section (13) from the gas turbine component (10), manufacturing a 3-D article, which fits in the gas turbine component (10) to replace the removed damaged section (13), and joining the gas turbine component (10) and the 3-D article inserted therein. Reduced cost, improved flexibility and productivity, and simplified handling are achieved by removing the damaged section (13) in the form of a cut-out section along a split line (14) as one single cut-out piece (15), measuring the cut-out piece (15) to obtain the actual non-parametric geometry data set of the cut-out piece (15), and manufacturing the 3-D article based on the geometry data set of the cut-out piece (15).

This application claims priority under 35 U.S.C. §119 to U.S. Provisional application no. No. 61/256,399, filed 30 Oct. 2009, the entirety of which is incorporated by reference herein.

### BACKGROUND

1. Field of Endeavor

The present invention relates to the technology of gas turbines, and also to a method for repairing a gas turbine component.

2. Brief Description of the Related Art

Today, gas turbines have turbine inlet temperatures of more than 1400° C. Accordingly, the components of those gas turbines such as blades, vanes or liners are exposed to a high thermal load and mechanical stress. As those components are usually made of expensive high-temperature resistant materials, it is desirable to repair those components, when damaged, instead of replacing them. However, the repair of damaged gas turbine components is of limited quality, when the damaged section is removed and an insert is manufactured to fit into the removed region, as the insert has to be manufactured with high precision to avoid a loss in mechanical stability and change in the flow characteristics of the machine.

Document EP 1 620 225 B1 discloses a method for repairing and/or modifying components of a gas turbine. Initially, at least one particularly damaged section of the component which is to be repaired, is extracted from the component. A CAD model is then produced for the replacement part by building the difference between nominal parametric CAD model and measured geometry data set of the damaged component. The replacement part is subsequently produced with the aid of an additive manufacturing process. Finally, the produced replacement part is integrated into the component, which is to be repaired.

U.S. Pat. No. 6,355,086 B2 discloses a method and apparatus for fabricating a component by a direct laser process. One example of such a component is a gas turbine engine blade having an abrasive tip formed directly thereon.

Document WO 2008/046386 A1 teaches a method for producing a gas turbine component with at least one closed outer wall and an inner structure bounded by the or each closed outer wall and defining hollow spaces, including the following steps: a) providing a three-dimensional CAD model of the gas turbine component to be produced; b) breaking down the three-dimensional CAD model into horizontal, substantially two-dimensional layers; c) building up layer by layer the gas turbine component to be produced with the aid of a additive manufacturing process using the layers generated from the CAD model in such a way that the or each outer wall is built up together with the inner structure and is accordingly connected to the inner structure with a material bond.

The document EP 1 231 010 A1 discloses a method of repairing gas turbine engine components. The method includes removing the damaged portion and fabricating an insert to match the removed portion. The insert is precision machined and crystallographically matched to the original component, and then bonded to this component using transient liquid phase bonding techniques and suitable heat treatment. Although the document contains a wealth of information on the bonding process, no details of the precision machining of the insert are given.

U.S. Pat. No. 5,269,057 teaches a method for replacing airfoil components includes the steps of identifying a portion of the airfoil to be replaced, removing the portion by a nonconventional machining process, such as continuous wire electrical discharge machining, and forming a replacement member utilizing a similar cutting process. A cutting path utilized to remove the portion to be replaced and to form the replacement member includes interlocking projections and sockets and may include one or more tapers along the cutting path so that the portion may be removed only by lifting in one direction. For the cutting, an electrical discharge cutting wire moves along the outside of a CNC programmed cutting path.

All the known methods for repairing gas turbine components are costly, have a low flexibility and productivity, and are difficult to put into practice. Furthermore, bad tolerances lead to bad quality, the dependence on a 3D model makes the repair expensive and elaborate, and these methods are limited to the repair of components with damages of low degradation and distortion.

### SUMMARY

One of numerous aspects of the present invention includes an improved method for repairing a partly damaged gas turbine component, which does not require a parametric CAD model of the cut-out piece of the component, which can be applied with reduced cost, resulting in improved flexibility and productivity, and has the advantage of high quality.

Another aspect of the present invention includes a method in which the damaged section is removed in the form of a cut-out section along a split line as one single cut-out piece, that the cut-out piece is measured to obtain the actual non-parametric geometry data set of the cut-out piece, and that the 3-D article is manufactured based on the geometry data set of the cut-out piece.

Throughout the following description, a “geometry data set” is meant to be a set of measured points representing a physical part; a “CAD model” is meant to be a, by means of a computer software created, virtual representation of a physical part, whereby in a “parametric” CAD model the geometry of the virtual representation is described by mathematical functions (e.g., NURBS), and in a “non-parametric” CAD model the geometry of the virtual representation is described by primitives such as points, triangles, rectangles, etc.

According to one embodiment, a virtual 3-D article in the form of a CAD model is created from said measured geometry data.

According to another embodiment, damaged or missing areas of the cut-out piece are virtually rebuild to create and/or modify and/or extend the CAD model.

According to another embodiment, the CAD model includes information about the inner surface, potential distortions, local wall thickness modifications and positions of cooling air holes of the ex-service gas turbine component.

According to another embodiment, an additional material surcharge is added around at least part of the split line to the geometry data set of the cut-out piece to allow for a compensation of the material loss due to cutting and/or the preparation of a split line surface and/or a final or individual adaptation of a standard 3-D article geometry to the individual ex-service gas turbine component to be repaired.

According to another embodiment, the 3-D article is manufactured by an additive manufacturing technology such as selective laser melting (SLM), selective laser sintering (SLS), or electron beam melting (EBM).

A method for making metallic or non-metallic products by a free-form laser sintering from a powder material is, for example, known from document DE 102 19 983 B4. Another method for manufacturing a moulded body, particularly a prototype of a product or component part, a tool prototype or spare part, in accordance with three-dimensional CAD data of a model of a moulded body, by depositing layers of a metallic material in powder form, is disclosed in document EP 946 325 B1. Furthermore, U.S. Pat. No. 6,811,744 B2 describes devices and arrangements for producing a three-dimensional object by a ray gun for controlled fusion of a thin layer of powder on the work table.

According to another embodiment, the 3-D article is manufactured by investment casting or milling.

According to a further embodiment, before joining the manufactured 3-D article into the ex-service gas turbine component, the manufactured 3-D article is recontoured into a recontoured 3-D article to reach optimum conditions of the split line surface and/or gap width for the final joining process.

Especially, the recontouring is done by removal of a fixed thickness of material.

As an alternative the recontouring may be done by individual adaptive machining.

According to another embodiment, the adaptive machining is based on the individually scanned ex-service gas turbine component, which is compared with the 3-D article geometry.

Alternatively, the adaptive machining may use a geometry data set based on the evaluation of a limited number of scanned gas turbine components of the same kind.

According to another embodiment, the recontouring process is done by a subtractive machining process, such as milling, grinding, or electro chemical machining (ECM).

According to just another embodiment, further to the recontouring, other pre-joining processes are applied to the 3-D article to make the 3-D article ready for insertion.

Preferably, the pre-joining processes include a heat treatment and/or chemical cleaning of the surfaces.

According to another embodiment of the invention the joining of the gas turbine component and the 3-D article is done by brazing or welding or a combination thereof.

### BRIEF DESCRIPTION OF THE DRAWINGS

The present invention is now to be explained more closely by description of different embodiments and with reference to the attached drawings.

FIG. 1 shows, in a side view, a damaged gas turbine component in form of a blade, which may be a starting point of the method according to the invention;

FIG. 2 shows the blade of FIG. 1 and the split line around the damaged region, where a single piece of a blade will be cut-out;

FIG. 3 shows an arrangement for measuring the geometry of the cut-out piece of FIG. 2;

FIG. 4 is a representation of the CAD model of the 3-D article to be manufactured for replacing the cut-out piece;

FIG. 5 shows the principles of the recontouring process of the manufactured 3-D article, whereby additional information from the gas turbine component itself may be used;

FIG. 6 shows how the manufactured and recontoured 3-D article is inserted into the gas turbine component to be repaired;

FIG. 7 shows the post machining process after the 3-D article into component have been joined; and

FIG. 8 shows in a process scheme various alternative routes of processing within the method of the invention.

### DETAILED DESCRIPTION OF EXEMPLARY EMBODIMENTS

In general, methods embodying principles of the present invention for repairing an ex-service gas turbine component include removing a damaged location, which method allows aright gap control, followed by replacing the respective location by a precisely fitting 3-D article. This 3-D article can be manufactured by additive manufacturing processes, such as selective laser melting (SLM), selective laser sintering (SLS), electron beam melting (EBM) or by standard methods, such as investment casting or machining process such as milling.

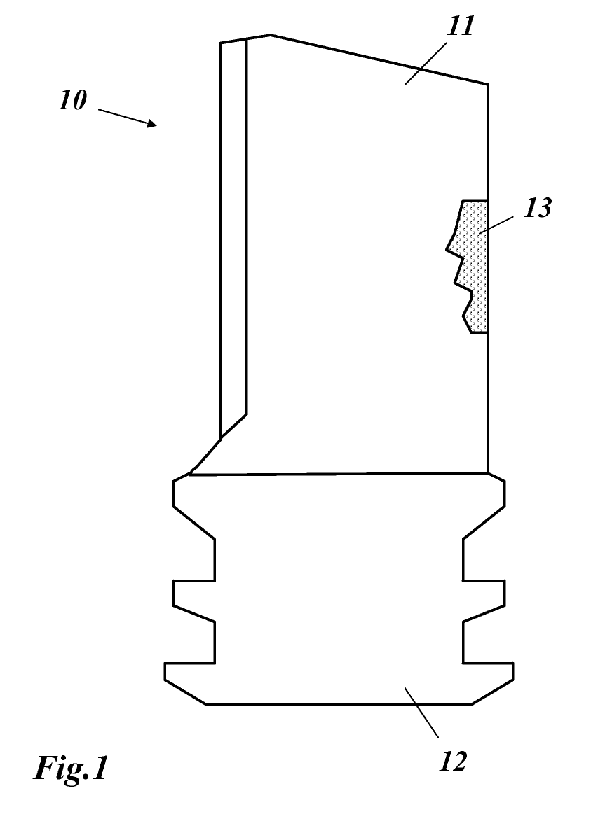

The method starts with the damaged gas turbine component an example of which is shown in FIG. 1. The gas turbine component 10 in this figure has the form of a turbine blade with an airfoil 11 and a root 12. This gas turbine component 10 is damaged as it shows a damaged area 13 at one of the edges of the airfoil 11.

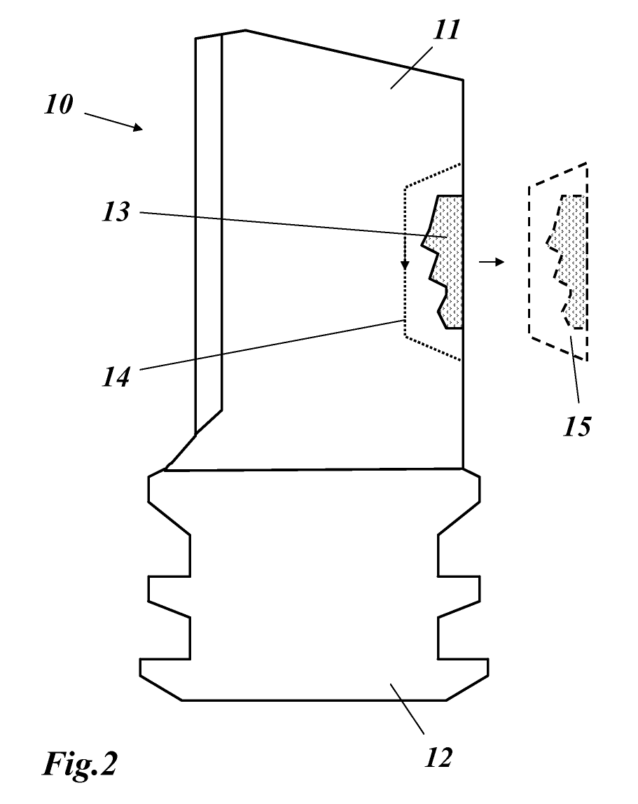

As shown in FIG. 2 the heavily damaged section or area 13 on the ex-service gas turbine component 10 is removed using a machining process, where the cut-out section will be available as one, single cut-out piece 15. Therefore, machining processes, such as electrical discharge machining (EDM), water jet, laser or plasma cutting are preferentially applied. With such machining processes the loss of material in the split line 14 between the cut-out piece 15 and the gas turbine component 10 can be reduced to a minimum. A milling or grinding process cannot be used, as no cut-out piece would be available. The machining process has preferably a marginal influence on the cutting area (no oxidation, small heat affected zone and low roughness).

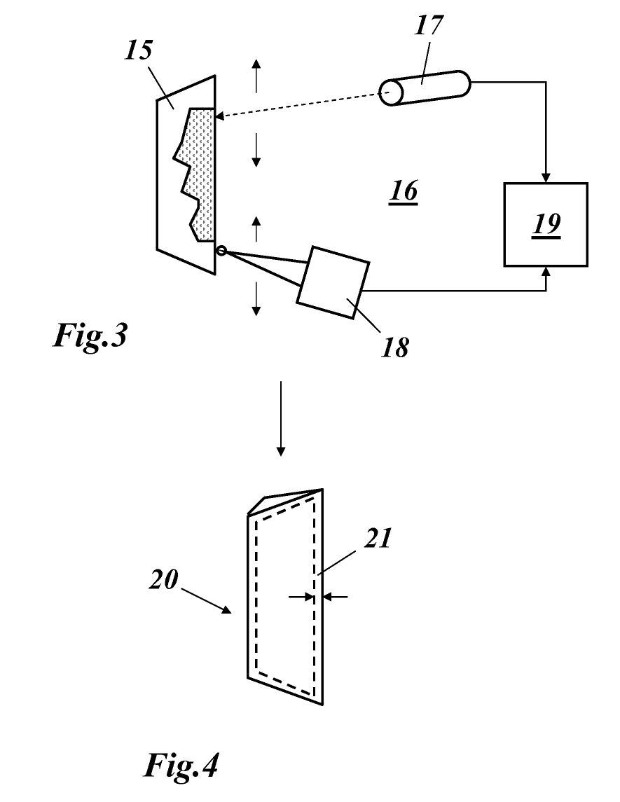

After the machining process the cut-out piece 15 including the damaged section (outer and inner contour) is measured using tactile or optical methods in order to obtain the actual, non-parametric geometry data set of this piece. FIG. 3 shows the respective optical or tactile measuring system 16, wherein an optical scanning head 17 and/or tactile scanning head 18, which are controlled in their movement by a control 19, are used to pick up the non-parametric geometry data set of the cut-out piece 15.

Next, the damaged/missing areas are virtually re-build and potentially modified (e.g. by Reverse Engineering) allowing to create and/or modify and/or extend a final CAD model of the cut-out piece 15, also called 3D article 20 (FIG. 4). The resulting CAD model of this 3D article 20 includes the information about the inner surface, potential distortions, local wall thickness modifications and position of cooling air holes of the ex-service component. An additional material surcharge 21 is added around at least part of the split line to the geometry data set of the cut-out piece 15. This allows a compensation of the material loss due to cutting, preparation of split line surface and, if needed, also a final or individual adaptation of a standard 3D article geometry to the individual ex-service gas turbine component 10 to be repaired.

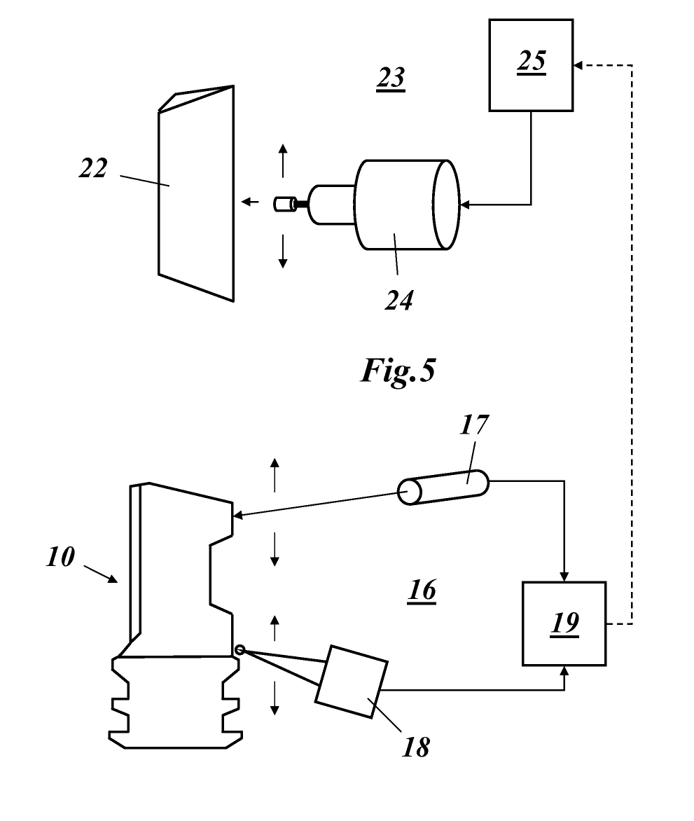

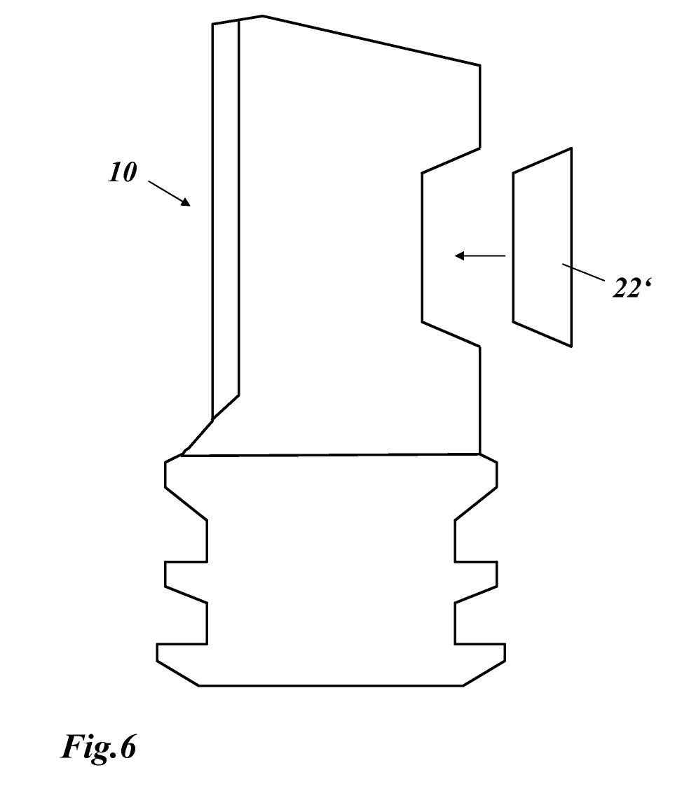

Based on the CAD model of the 3-D article 20 the reconditioning procedure continuous with the manufacturing of a real 3-D article (22 in FIG. 5). For the related subsequent reconditioning chain three different approaches are generally possible:
The first variant generally allows the manufacturing of the 3-D article 22 in form of a component of standard size without any additional information or measurement of the individual ex-service gas turbine component 10 to be repaired. There is a standard material surcharge on the standard cut-out piece for compensation of the cutting process and for surface preparation for joining. Accordingly, no 3-D model or measurement of the gas turbine component 10 is used. The fixed thickness of material is removed during recontouring (see upper half of FIG. 5, where a machining system 23 with a machining tool 24 into respective control 25 are used for recontouring).
The second option would include a post machining (adaptive machining) of a standardized replacement article or “coupon” based on the individually scanned ex-service gas turbine component with aperture (see lower half of FIG. 5), which is compared with the 3-D article geometry. In this case the gas turbine component or blade 10 to be repaired has to be individually scanned, or alternatively, a geometry data set based on the evaluation of a limited number of scanned blades is used.
The third alternative would ask for an individual scanning of each gas turbine component or blade 10 to be repaired after removal of the damaged area in order to generate individual machine data sets for the additive manufacturing of respective 3-D articles.

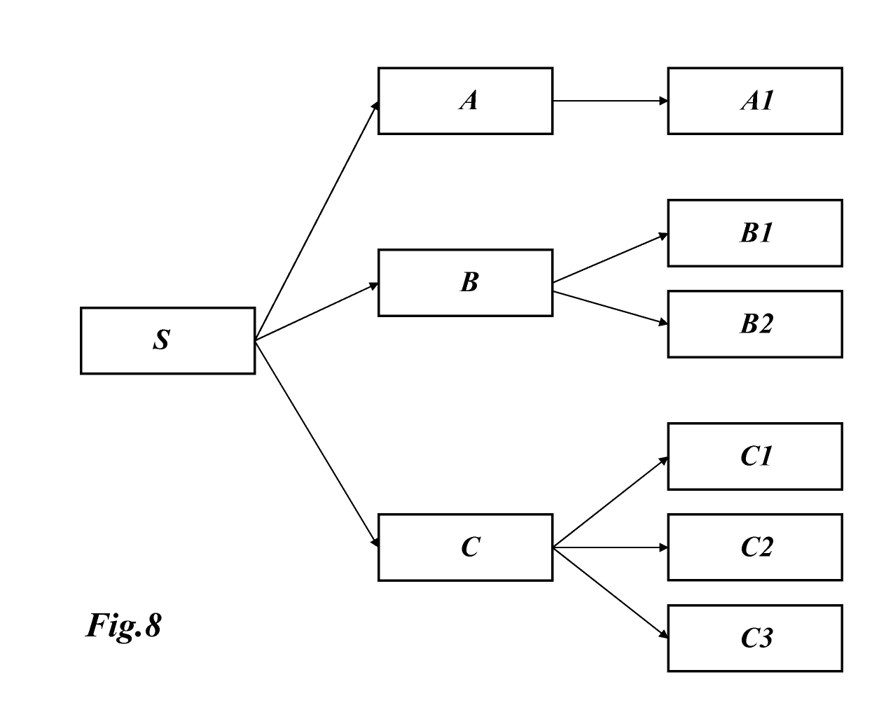

The selection of the best suited variant strongly depends on the degree of deformation to be expected on the individual parts of a set of blades to be repaired. FIG. 8 shows in a process scheme various alternative routes of processing within the method of the invention. The scheme begins with the start S that is the measurement of the cut-out piece 15.

Variant A is favoured, when the gas turbine component 10 to be repaired has only low distortion and damages. In this case, a standard material surcharge on the standard cut-out piece is provided for compensation of cutting process and for surface preparation for joining. No 3-D model or measurement of the gas turbine component are necessary; a layer of fixed thickness is removed (A1).

Variant B is favoured, when the gas turbine component 10 to be repaired has medium distortion and damages. In this case, a standard material surcharge on the cut-out piece is provided plus additional oversize for adaptive machining and for surface preparation for joining. When the joining process requires only a medium/low gap precision, a statistical evaluation of damages of components is used for the generation of a model and material removal with fixed thickness (B1). When the joining process requires a high gap precision, each component is measured and adaptive machining is applied (B2).

Variant C is favoured, when the gas turbine component 10 has a high distortion and worn out locations. In this case, there is an individual manufacturing of the inserts with a material surcharge on the cut-out piece for compensation of the cutting process and for the surface preparation for joining. When the joining process requires only a low gap precision, either no 3-D model or measurement of the gas turbine component are necessary and a layer of fixed thickness is removed (C1), or a statistical evaluation of damages of components is used for the generation of a model and material removal with fixed thickness (C2). When the joining process requires a high gap precision, each component is measured and adaptive machining is applied (C3).

Based on the generated geometry data set of the cut-out piece, the 3D article 22 can be manufactured by an additive manufacturing technology, such as selective laser melting (SLM), selective laser sintering (SLS) or electron beam melting (EBM). Also conventional methods, such as investment casting or milling can be used. The decision of the manufacturing technology also depends on the degree of deformation to be expected on the individual parts of a set of blades to be repaired.

Before joining the manufactured 3-D article 22 into the ex-service gas turbine component 10, each 3-D article 22 needs to be recontoured to reach optimum conditions of the split line surface (e.g. roughness, gap geometry/tolerance) for the final joining process. Depending on the selected approach, the recontouring step can be done by removal of a fixed value (thickness) or by individual adaptive machining. For the recontouring a standard process is used, such as milling, grinding or electro chemical machining (ECM); FIG. 5 shows an exemplary machining system 23 for recontouring the manufactured 3-D article 22 into a recontoured 3-D article 22′, with a rotating machining tool 24 and a respective control 25. Besides the recontouring, other pre-joining processes (and chemical cleaning of the surfaces to be joined) may be needed depending on the manufacturing process, e.g. pre-heat treatments for improved weldability, stress relief heat treatments for 3D articles made by additive manufacturing technologies, etc.

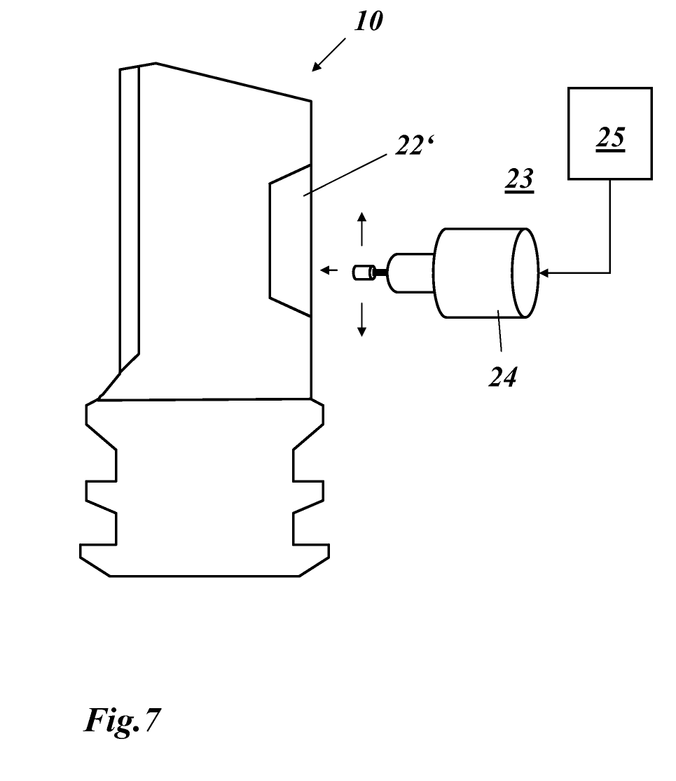

The joining of the manufactured 3D article into the ex-service gas turbine component 10 can be realized with a standard and specifically adapted joining process, such as brazing or welding or a combination thereof. A final heat treatment and post machining (see FIG. 7) is carried out at the end of the reconditioning chain.

Some potential advantages of the method over the known technologies are:
No measurement of the whole component to get the information about the ex-service influence such as distortion, depending on approach.
No CAD model of the whole component is required.
No parametric CAD model of the 3D article (cut-out piece) is required.
Characteristic issues/information of the cut-out piece due to service and new manufacturing are covered with the scan of the cut-out piece.
Cost and scrap rate reduction.
Flexibility and productivity are improved.
Extended repair to highly loaded areas.

### LIST OF REFERENCE NUMERALS

10 gas turbine component (e.g. turbine blade)
11 airfoil
12 root
13 damaged section
14 split line
15 cut-out piece
16 measuring system (optical or tactile)
17 optical scanning head
18 tactile scanning head
19 control
20 3-D article (data set)
21 material surcharge
22 3-D article (manufactured)
22′ 3-D article (recontoured)
23 machining system
24 machining tool
25 control
S start
A,B,C repair process requirement
A1,B1,B2 repair process requirement
C1,C2,C3 repair process requirement

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A method for repairing an ex-service gas turbine component comprising:
removing a damaged section from said gas turbine component;
manufacturing a 3-D article which fits in said gas turbine component to replace the removed damaged section; and
joining said gas turbine component and said 3-D article inserted therein;
wherein removing the damaged section comprises removing in the form of a cut-out section along a split line as one single cut-out piece;
measuring the cut-out piece to obtain the actual non-parametric geometry data set of the cut-out piece; and
wherein manufacturing said 3-D article comprises manufacturing based on said geometry data set of the cut-out piece.

2. A method according to claim 1, further comprising:
creating a virtual 3-D article in the form of a CAD model from said measured geometry data.

3. A method according to claim 2, wherein creating a virtual 3-D article comprises virtually rebuilding damaged or missing areas of the cut-out piece to create, modify, extend, or combinations thereof, said CAD model.

4. A method according to claim 2, wherein the CAD model includes information about the inner surface, potential distortions, local wall thickness modifications, and positions of cooling air holes of the ex-service gas turbine component.

5. A method according to claim 1, further comprising:
adding an additional material surcharge around at least part of the split line to the geometry data set of the cut-out piece to allow for
a compensation of the material loss due to cutting,
the preparation of a split line surface,
a final or individual adaptation of a standard 3-D article geometry to the individual ex-service gas turbine component to be repaired,
or combinations thereof.

6. A method according to claim 1, wherein manufacturing the 3-D article comprises manufacturing by an additive manufacturing technology.

7. A method according to claim 6, wherein the additive manufacturing technology is selected from the group consisting of selective laser melting (SLM), selective laser sintering (SLS), and electron beam melting (EBM).

8. A method according to claim 1, wherein manufacturing the 3-D article comprises manufacturing by investment casting or milling.

9. A method according to claim 1, further comprising, before said joining the manufactured 3-D article into the ex-service gas turbine component:
recontouring the manufactured 3-D article into a recontoured 3-D article to reach optimum conditions of the split line surface, gap width for the final joining process, or both.

10. A method according to claim 9, wherein recontouring comprises removing a fixed thickness of material.

11. A method according to claim 9, wherein recontouring comprises individual adaptive machining.

12. A method according to claim 11, wherein said adaptive machining is based on the individually scanned ex-service gas turbine component, which is compared with the 3-D article geometry.

13. A method according to claim 11, wherein said adaptive machining uses a geometry data set based on the evaluation of a limited number of scanned gas turbine components of the same kind.

14. A method according to claim 9, wherein recontouring comprises a subtractive machining process.

15. A method according to claim 14, wherein said subtractive machining process is selected from the group consisting of milling, grinding, and electro chemical machining (ECM).

16. A method according to claim 9, wherein recontouring further comprises heat treatment, chemical cleaning of the surfaces, or both, of the 3-D article to make the 3-D article ready for insertion.

17. A method according to claim 1, wherein said joining of said gas turbine component and said 3-D article comprises brazing, welding, or a combination thereof.
